(19) United States
(12) Patent Application Publication
(10) Pub. No.: US 2012/0219370 A1
(43) Pub. Date: Aug. 30, 2012

(54) CUTTING TOOL, IN PARTICULAR PARING TOOL, DRILL HEAD, SOLID DRILL HEAD OR BORING HEAD, AND CUTTING MACHINE AND METHOD

(75) Inventor: Alfred Ostertag, Celle (DE)

(73) Assignee: FERROLL GMBH, Celle (DE)

(21) Appl. No.: 13/499,474

(22) PCT Filed: Oct. 1, 2010
(86) PCT No.: PCT/DE2010/001152

§ 371 Date: May 14, 2012

(30) Foreign Application Priority Data
Oct. 2, 2009 (DE) 10 2009 048 057.9
Mar. 30, 2010 (DE) 10 2010 013 480.5

(51) Int. Cl. B23B 49/00

(52) U.S. Cl. 408/16

(57) ABSTRACT

Rotationally symmetrical bodies consisting of metal materials must often be provided with cylindrical drilled holes following a central and straight progression. These drilled holes extend in part over the entire length, so that drilling yields a tubular body. If drilled holes with a depth>10 times the average are needed, deep drilling machines are used. This drilling depth combined with structural details may give rise to deviations from the drilling axis and work piece axis. This may lead to scrap. Therefore, the invention proposes a core drill head or solid drill head that exhibits a directional controller for use in deep drilling machines.

The invention relates to a peeler, in particular in the form of a core drill head, a solid drill head, a drill head or a cutting tool, and a metal cutting machine, as well as to diverse methods for controlling cutting tools.

Rotationally symmetrical bodies consisting of metal materials must often be provided with cylindrical drilled holes following a central and straight progression. This drilled hole extends in part over the entire length, so that drilling yields a tubular body. If the drilled hole does not extend over the entire length, the drilled hole is referred to as a tapped blind hole. Drilled holes with a depth exceeding 10 times the diameter, for example, are fabricated using deep drilling machines. The components used for such drilled holes must follow a precise and straight progression.

In order to perform the drilling process, a drill head is attached to a drill pipe, which conveys both the torque required for drilling and the feeding force from the drilling machine to the drill bead via the drill pipe. The used drilling machines are often configured in such a way that only the drill pipe and allocated drill head or only the work piece to be machined or both the drill head and the work piece rotate against the feed. If deep drilling machines are used, the counter-rotating arrangement is preferred with respect to the straightness of the drilled hole.

However, neither this measure nor other structural details relative to tools in prior art can prevent the drilling axis from deviating from the work piece axis. Deviations exceeding a certain permissible level routinely result in the production of scrap. General variables that may cause this deviation include:
The drill pipe sagging under its own weight, along with drill buckling, which results in drill head misalignment. In addition, the sag can change continuously due to exposure to oscillations.
Differing material properties, e.g., strength or hardness,
And the existing drilled hole experiences a strong curvature or eccentricity, especially during core drilling.

The first disturbance variable mentioned can be eliminated or tangibly reduced by using a stabilizing drill set. However, the other disturbance variables cannot be appreciably influenced in this way.

In addition, the work piece to be machined can itself be responsible for extensive disturbance variables. Even though the work pieces are prepared and clamped in such a way that the intended drilled hole axis is identical with the machine axis, errors in the straightness and centricity of the outer diameter may result in the outer diameter of the work pieces not being concentric to the intended drilled hole axis. This applies in particular to materials fabricated out of hot rolled pipes with comparatively high production tolerances. This most often precludes any measurement of the drilled hole progression by making reference to the outer diameter. The drilled hole progression can only be measured after machining is complete for such work pieces. Here as well, materials that exhibit an impermissible deviation of the desired axis progression are separated out as scrap.

The object of the invention is to improve prior art.

In a first aspect of the invention, this object can be achieved with a peeler, which is can be used and is provided in particular for manufacturing eccentric screws, and exhibits a directional controller.

As a result, deviations that arise while setting up an eccentric screw, for example, can be influenced by controlling the direction of the peeler.

By way of explanation, let it be noted from a terminological standpoint that this application refers to “controlling” for the sake of simplicity. However, in terms of content, this also encompasses “regulating”.

To prevent the eccentric screw to be generated from sagging under its own weight, the peeler can exhibit a floating support structure.

In a special embodiment, the peeler exhibits a peeling knife and actuator, wherein the peeling knife is positioned by means of the actuator, thereby realizing the directional controller. As a result, the peeler can be provided with a simple directional controller.

In particular, the peeler can be prepared by altering the function of an OMEGA system from ECOROLL, which exhibits a peeling head with three floating peeling knives and an also floating support structure located in the middle, so that the peeling knives are no longer floating, and controlled strictly by means of the actuators.

Both here and further in the text, an “actuator” is an actuator that can be controlled via electronic or pneumatic or hydraulic signals, which is able to influence a positional change in a defined manner. In the present case of the peeling knives, the actuators can radially effect a directional correction.

In order to finish roll the work piece machined with the peeler immediately thereafter, the peeler can exhibit a finish roll element. This is here already ensured if the peeler and finish roll element can act on the work piece when clamped in a metal cutting machine.

In order to provide predrilled work pieces with a precisely drilled hole, the object can be achieved in another aspect of the invention by means of a core drill head, a radially external side of which exhibits a cutting element, so that a hole can be enlarged in a defined manner via a metal-removing operation, wherein the core drill head exhibits a directional controller.

What follows is a terminological clarification.

A “core drill head” is a tool for a drilling machine or deep drilling machine, which enlarges a predrilled hole to a target diameter,

For example, the “cutting element” can be comprised of cutting edges, which are located in an outer position of the drill head, and when advanced into the predrilled hole lead to a “metal-removing operation” caused by contact with the material of the work piece.

In order to realize the directional controller for the core drill head, the core drill head can exhibit an actuator.

Since the core drill head is normally guided with guiding means, the directional controller can be easily converted by having the actuator be able to deflect a guiding strip in a defined manner and/or having the actuator adjust the angle of the core drill head.

In order to be able to realize a precisely drilled hole even during a machining process in solid material, the object can be achieved in another aspect of the invention by a solid drill head, the face of which exhibits a cutting element in the advancing direction, so that an advancing motion is accompanied by a metal-removing operation, and which exhibits a directional controller with an actuator, wherein a guiding strip can be deflected in a defined manner via the actuator and/or the actuator brings about a defined angular position of the core drill head.

The tool can here also be guided via the guiding strip.

In a solid drill head, the cutting elements are distributed over the circumference in a radial direction in such a way that the entire drilling cross section can be machined.

In addition, the solid drill head can exhibit a central drilled hole, so that the cooling lubricant can be removed along with the shavings against the advancing direction in the center of the work piece in corresponding deep drilling systems.

The “advancing motion” is realized in such a way that, as the work piece and/or solid drill head is rotated, the solid drill head is pressed against the work piece with a specific force. As a result, the cutting elements bring about a “metal-removing operation” on the work piece.

In another aspect of the invention, the object can be achieved with a drill head exhibiting a tool holder, in relation to which a direction is changed via the directional controller.

As a consequence, the direction of the drill head can be changed without having to alter the position of the tool holder.

The “drill head” can especially be realized as a core drill head or solid drill head, so that “drill head” is to be understood as an umbrella term for “solid drill head” and “core drill head”.

In particular, a “tool holder” encompasses a drill pipe, with which the drilling machine or deep drilling machine is joined with the cutting element.

In order that a torque can be applied to the cutting elements, causing the actual metal-removing operation to actually take place, the drill head can exhibit a torque receiver, which engages with the tool holder. As a consequence, the torque of the drilling machine or deep drilling machine can be conveyed to the cutting elements via the tool holder.

In an additional aspect, the object is achieved by means of a cutting tool, wherein the actuator is designed as a pneumatic actuator, hydraulic actuator or electrical actuator. As a consequence, alternative actuator concepts can be offered.

A “cutting tool” can encompass all drill heads, solid drill heads, core drill heads or peelers described above. “Cutting tool” is here to be understood as an umbrella term.

In order to detect a deviation of the cutting tool from a prescribed alignment, the cutting tool can exhibit a deviation detector, which detects a deviation of the cutting tool from a desired alignment.

This deviation detector is the precondition for a regulating or controlling operation involving the directionally adjustable cutting tool, so that a precise alignment can be ensured even across large drilling depths.

In order to provide the simplest possible deviation detector, the latter can exhibit a force sensor. Since the work piece to be machined rotates, the deviation from the center of the machine axis caused by an eccentric rotation of the work piece can be detected by measuring the force. In the event a precisely drilled hole is present, the force equals zero. Given an eccentricity, the force is greater than zero.

If the cutting tool rotates, the eccentricity makes the centrifugal force greater than it would be in the absence of eccentricity. As a consequence, measuring the centrifugal force makes it possible to arrive at a conclusion about cutting tool eccentricity, and hence drilled hole progression. In this case, the force sensor is configured as the centrifugal force sensor.

In another configuration, the deviation detector exhibits a guide beam and a detector allocated to the guide beam. If the detector signal deviates from the guide beam, a cutting tool deviation may also be inferred from this.

In order to ensure a precisely drilled hole during the drilling process in one go, the cutting tool can exhibit a regulator, in which a regulating algorithm is stored, wherein the regulator is connected with the deviation detector and directional controller, so that a deviation of the cutting tool leads to a compensation via the directional controller.

In the case of the centrifugal force sensor, the centrifugal force is continuously measured during the entire drilling process. The regulator is here set up in such a way as to minimize the proportion of eccentricity.

Let it be reiterated at this juncture that the actuators can act on the cutting tool in two different ways. On the one hand, the eccentric position of the drill head can be modified via the guiding rails, for example. A variable angular deviation between the axis of the drill pipe and drill head is also possible.

In one embodiment, the cutting tool exhibits a drill pipe, wherein the drill pipe is joined in particular with the tool holder in a torque-proof manner. The advantages to this configuration have already been enumerated.

In order to take the load off of the regulator, the drill pipe can exhibit a stabilizing drill set. As a consequence, influences owing to the intrinsic weight of the drill pipe and cutting tool can be diminished.

In order to increase the production efficiency for the tool to be fabricated, the tool holder for the cutting tool and/or the drilling and/or cutting tool can exhibit a finishing device, with which a surface created by the cutting tool can be machined in a machine setup. In particular, such a finishing device can be a finish roll element, which alters the surface created by cutting in such a way that the latter in particular becomes more durable.

In another aspect, the object can be achieved by means of a metal cutting machine, in particular a deep drilling machine, which exhibits a peeler described above and/or a core drill head described above and/or a solid drill head described above and/or a drill head described above and/or a cutting tool described above.

This makes it possible to manufacture not just a tool, but also a metal cutting machine. For example, such a metal cutting machine can be a lathe or whirling machine.

In an additional aspect, the object is achieved with a method for controlling a cutting tool, wherein the direction of a cutting tool is adjusted via an angular adjustment and/or a deflection of guiding strips.

Therefore, alternatives can be provided for changing the direction of a cutting tool. The cutting tool must be understood in particular in the light in which already described above.

The “angular adjustment” is accomplished by means of variable angular deviation, for example which takes place between the axis of the drill pipe and drill head.

In particular, altering the guiding strip axes leads to a change in the cutting tool axis.

In another aspect, the object can be achieved by a method for determining the deviation of a tool from a desired direction, wherein the deviation is determined by means of a centrifugal force sensor and/or a guide beam and accompanying detector.

In particular a measured value of the centrifugal force sensor is here determined and compared with an expected value. For example, if the value is higher than the expected value due to the eccentricity, a deviating direction is present, which can be offset by adjusting the direction of the tool.

For example, the guide beam can be designed as a laser, and the accompanying detector is a location-sensitive light detector, such as a CCD camera, or a position-sensitive photo sensor. If the light beam no longer hits the desired point on the detector, the detector signal can be used to determine the direction in which the tool has deviated.

This is the precondition for another aspect, in which the object is achieved by providing a method for controlling the tool along a rotational axis, wherein the rotational axis coincides with the rotational axis of the machine, a deviation by the tool from the rotational axis is detected, and the tool is deflected in a direction toward the rotational axis.

The deviation from an axis can be determined based on the designated method described above. Based on this deviation, the actuators are used to controllably act on the cutting tool, for example, so that the cutting tool again moves in the direction of the desired rotational axis. In particular, this takes place continuously, so that the actuators are set to the “zero position” when the rotational axis has been reached.

In an embodiment relating to the above, the tool can be a peeler described above, a core drill head described above, a solid drill head described above, a drill head described above or a cutting tool described above.

In another aspect of the invention, the object is achieved with a method for machining a work piece, wherein the work piece in particular consists of metal, and the method takes place on a previously described metal cutting machine, wherein an advancing motion and rotation are imparted to the peeler or core drill head or solid drill head or drill head or cutting tool and/or the work piece, thereby cutting a small fragment from the work piece.

This makes it possible to prepare a work piece whose drilled holes are more precisely machined, thereby reducing the likelihood of the work piece resulting in scrap.

In a related embodiment, a counter-rotation is imparted to the work piece by comparison to the rotation of the peeler or core drill head or solid drill head or drill head or cutting tool.

A higher productivity can be ensured as a result.

In another aspect of the invention, the object can be achieved with a work piece manufactured in one of the methods described above.

The invention will be described in greater detail below based on an exemplary embodiment and drawing reference to the figures. Shown on:

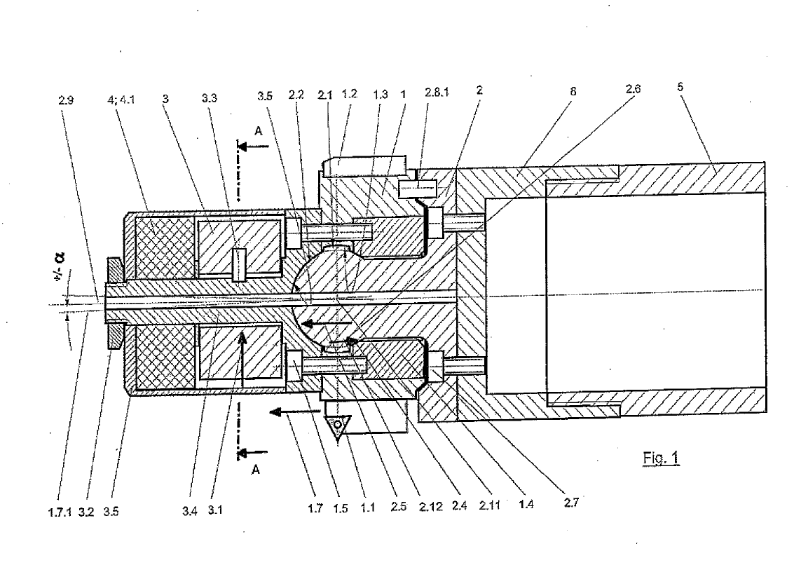

FIG. 1 is a diagrammatic longitudinal section of a core drill head,

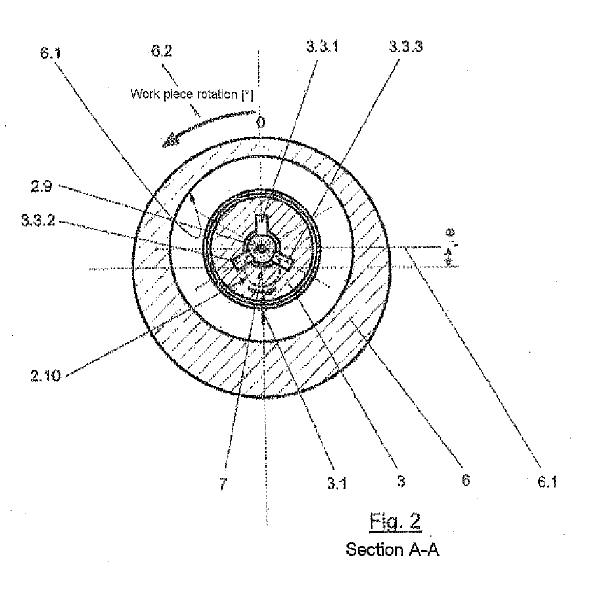

FIG. 2 is a diagrammatic cross section of the core drill head from FIG. 1 in the sectional plane according to designation A-A therein, and

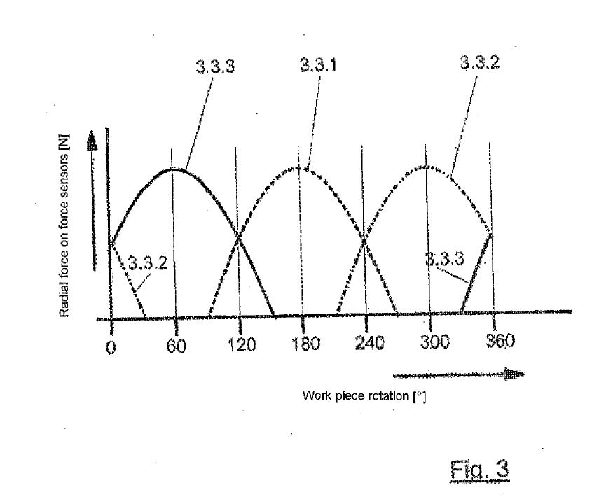

FIG. 3 is a diagram showing the dependence of centrifugal force on a rotational angle of a work piece for three centrifugal force sensors.

In a preferred embodiment of a drill head 1, the latter is coupled to a deep drilling machine (not shown) by means of a drill pipe 5. The drill head 1 exhibits one or more cutting edges 1.1 designed as replaceable cutting inserts. At least two wear-resistant guiding strips 1.2 are arranged at expedient locations on the circumference of the drill head 1.

Arrow 1.7 shows the advancing direction of the tool 1. The locating hole of the drill head 1 is provided with teeth or otherwise configured interlocking elements 1.3 for purposes of torque transfer. These engage torque-transferring elements 2.1 of a driving flange 2, The latter is furnished with a spherical surface 2.2 in the forward advancing direction, and with a spherical surface 2.4 in the rearward advancing directions. A corresponding concave, spherical surface 3.5 is located at the rear end of an axis 3.4, and contacts the spherical surface 2.2.

A ring 1.4 divided into two halves envelopes the spherical surface 2.4 of the driving flange 2. It is bolted to the axis 3.4 by means screws 1.5 with virtually no play, in such a way that the arising unit comprised of the drill head 1, axis 3.4 and split ring 1.4 can be pivoted in all directions relative to the driving flange 2.

However, this unit cannot be twisted relative to the driving flange 2. The arc-shaped drivers 2.1 as well as the spherical surfaces 2.2 and 2.3 have a shared midpoint 2.11. The drill head 1 can be continuously pivoted in any direction around this midpoint by a variable angle α. This movement leads to a change in the drilling direction, and thus is a desired adjustment motion to correct the drilled hole progression.

The angular mobility of the drill head is alternatively achieved by means of other configurations. For example, the driving flange 2 can be connected with the drill head 1 via a shaft with an elastically bendable region. These and other variants are not depicted.

Three electronic actuators 2.8 distributed uniformly on the circumference, wherein actuator 2.8.1 is representatively shown on FIG. 1, are arranged in such a way as to hold the drill head in the alignment of a tool axis 2.9 given a centrally running drilled hole. If an arising eccentricity of the drilled hole necessitates an angular deflection of the drill head 1 for correction purposes, the actuators 2.8 alter the angular position of the drill head 1 by the variable deflection angle α relative to the tool axis 2.9. As an alternative, hydraulic actuators are used in place of the electronic actuators 2.8.

The control unit consists of the axis 3.4, a housing 3.5 and a concentric ring 3 accommodated therein, wherein the ring 3 exhibits a mass, and further of an electronic regulator 4 and a battery 4.1 required for supplying power to the regulator 4.

The concentric ring 3 is situated so it can move on all sides in a radial direction, and is supported relative to the axis 3.4 by means of three force sensors 3.3. An anti-twist device (not shown) holds the ring 3 in a constant angular position relative to the axis 3.4. The control unit is secured to the axis 3.4 by means of a groove 3.2.

For illustration purposes, reference is made to the arrangement of force sensors 3.3 on FIG. 2. The force sensors are marked 3.3.1 to 3.3.3.

The drill head 1 described above is rigidly screwed to a tool holder 8 by means of the screws 2.7 so that it cannot twist.

The tool holder 8 is screwed to the drill pipe 5 with a standardized connection thread. The drill pipe 5 transfers the advancing force 2.5 generated by the deep drilling machine, which is imparted to the drill head unit 8,5,1 by way of the driving flange 2. At the same time, the drill pipe 5 absorbs the reaction torques that arise during the drilling process while the work piece is rotating.

A force 2.12 introduced while pulling the tool 1 away from the drill pipe 5 acts on the drill head unit via the rearward spherical surface 2.4.

In the event of an undesired drilled hole progression, the central axis of a drilled hole 6.1 exhibits an eccentricity e relative to the central axis 7 of the deep drilling machine. The work piece 6 rotates in the direction of an arrow 6.2 around the deep drilling machine axis 7. A tool axis 2.9 here describes an orbit 2.10 having a radius e. During this rotation, the mass of the ring 3 generates a centrifugal force 3.1, a respective half of which is absorbed by part of the force sensors 3.3.2, 3.3.3 in the instantaneous position depicted.

In this state, no force acts on the sensor 3.3.1. During the entire rotation, the direction of centrifugal force always runs in the radial direction, which is formed by the connecting line between the deep drilling machine axis 7 and tool axis 2.9.

The diagram on FIG. 3 shows how the centrifugal force 3.1 is distributed to a respective one to two of the three sensors 3.3 as a function of the rotational angle of the work piece. The magnitude of centrifugal force depends on the constant mass of the ring 3, the constant work piece speed, as well as the variable eccentricity.

As the work piece rotates in the synchronous orbit 2.10, the sensors 3.3 measure both the magnitude and direction of centrifugal force. Both magnitudes are variable. In addition to the centrifugal force, the ring 3 exerts a weight force constant in terms of magnitude and direction toward the earth's center. The latter has no importance relative to tool function, and is thus filtered out in the regulator 4.

The two variables are processed in the regulator 4 and output to the actuators 2.8 as corrective signals. One sensor 3.3.1 to 3.3.3 is allocated to each of the actuators 2.83 to 2.8.3 (only actuator 2.8.1 is depicted as a reference). In order to reduce the eccentricity e, the actuation motion changes the drilling direction to opposite the centrifugal force.

The actuators 2.8 uniformly distributed on the circumference are operated in such a way as to deflect the axis of the drill head 1 opposite the direction of the centrifugal force by the angle α. This changes the drilling direction. After the actuation motion is completed, the drilled hole runs along the axis 1.7.1 at an angle α. The magnitude of the deflection angle is regulated as a proportional function of the magnitude of the centrifugal force, and hence directly dependent upon the eccentricity e.

It follows from the above that continuing the drilling process at the instantaneous deflection angle α reduces the eccentricity e. The centrifugal force diminishes accordingly. As a result, the deflection angle α decreases continuously. At an eccentricity e of zero, the centrifugal force and deflection angle are also zero. In this case, the drilled hole axis coincides with the machine axis.

The regulating process and movement sequences have here been described for the simple case in which only the work piece rotates, and the tool is stationary when operated. In the interest of a higher productivity, users will also allow the tool to counter-rotate in deep drilling machines, which are equipped with counter-rotation capability.

The directional controller is adjusted for this type of operation. The centrifugal force 3.1 critical for controlling the drill runs synchronously with the work piece speed. It is continuously measured by the sensors 3.3.1 to 3.3.3. The relative movement of the tool opposite the work piece rotation causes each sensor 3.3.1 to 3.3.3 to run through the acting direction of the centrifugal force repeatedly per work piece rotation. The drill head 1 is deflected opposite the acting direction of the centrifugal force 3.1 by a variable angle α. The direction of the deflection angle α here always coincides with the direction of the circumferential centrifugal force.

The significant change is that the 3 actuators run through the direction of the deflection angle α once for each tool rotation. With respect to the regulator 4, this would imply an increased frequency of control pulses for the force sensors 3.3 and actuators 2.8. This is technically realized during the structural configuration of these elements 3.3, 2.8 and the regulator 4.

In an alternative embodiment, the actuators 2.8 are located between the drill head 1 and guiding strips 1.2. This embodiment is not shown on the drawings. An angular mobility of the drill head 1 relative to the tool is not required in this embodiment. Instead, the guiding strips 1.2 can move in a radial direction. In this case, the control movement takes place by deflecting the guiding strips 1.2 in a radial direction.

The invention will be applied to solid drills as an example. In this case, the drill head 1 is configured in such a way that the control unit is situated behind the drill head 1 in the advancing direction, and that the cutting edges are distributed in a radial direction and over the circumference, so that this arrangement machines the entire drilled hole cross section. In addition, the control unit is structurally provided with a continuous central drilled hole, so that the cooling lubricant and shavings are removed against the advancing direction in the center of the tool in accordance with the deep drilling machine system.

The directional controller is alternatively built into individual peelers or peelers combined with finish roll tools. To this end, one realization involves adjusting an OMEGA system from ECOROLL with three floating peeling knives and an also floating support structure located in the middle. The actuators are here arranged in such a way that the peeling knives no longer float freely, and are radially deflected by the actuators for purposes of directional correction.

### Reference List:

1 Drill head
1.1 Cutting edges
1.2 Guiding strips
1.3 Torque transfer elements
1.4 Split ring
1.5 Screws
1.6 Spherical surface
1.7 Arrow for advancing direction
2 Driving flange
2.1 Driving elements
2.2 Spherical surface
2.4 Spherical surface
2.5 Advancing force
2.6 Housing
2.7 Screws
2.8 Actuators
2.9 Tool axis
2.10 Orbit of tool axis (2.9)
2.11 Midpoint of spherical surfaces
3 Concentric ring (mass)
3.1 Centrifugal force (measured variable)
3.2 Nut
3.3 Force sensors (3.3.1 to 3.3.3)
3.4 Axis
3.5 Housing
4 Regulator
4.1 Battery
5 Drill pipe
6 Work piece
6.1 Central axis of drilled hole
6.2 Arrow for work piece rotation
7 Deep drilling machine axis
8 Tool holder or follow-on tool

1-26. (canceled)

27. A core drill head, which exhibits a cutting element on a radial external side, so that a hole can be enlarged in a defined manner via a metal-removing operation, wherein the core drill head exhibits a directional controller with an actuator, which deflects a guiding strip or causes an angular adjustment of the core drill head, and a deviation detector, wherein the deviation detector detects a deviation of the cutting tool from a desired alignment, wherein the deviation detector exhibits a force sensor, which is configured as a centrifugal force sensor.

28. The core drill head according to claim 27, comprising a regulator, in which a regulating algorithm is stored, wherein the regulator is connected with the deviation detector and directional controller, so that a deviation of the cutting tool leads to a compensation via the directional controller.

29. The core drill head according to claim 27, wherein a guiding strip can be deflected via the actuator and/or adjusting the actuator causes an angular adjustment of the core head drill.

30. The core drill head according to claim 27, comprising a tool holder and/or a work piece holder, in relation to which a direction is changed by means of the directional controller.

31. The core drill head according to claim 30, wherein a torque receiver is provided, which engages with the tool holder.

32. The core drill head according to claim 30, wherein an actuator is provided in the form of a pneumatic actuator, hydraulic actuator or electronic actuator.

33. The core drill head according to claim 30, comprising a drill pipe, wherein the drill pipe is joined in particular with the tool holder in a torque-proof manner.

34. The core drill head according to claim 33, wherein the drill pipe exhibits a stabilizing drill set.

35. The core drill head according to claim 33, wherein the tool holder and/or the drill pipe and/or the cutting tool exhibit a finishing device, with which a surface created by the cutting tool can be machined in a machine setup.

36. A metal cutting machine, in particular a deep drilling machine, comprising a core drill head according to claim 33.

37. A method for controlling a tool along a rotational axis, wherein the rotational axis coincides with the rotational axis of the machine, wherein a deviation by the tool from the rotational axis is detected, and the tool is deflected in a direction toward the rotational axis, wherein the tool exhibits a core drill head according to claim 27.

38. A work piece, wherein it is manufactured with a device according to claim 27.
